(19) United States
(12) Patent Application Publication
(10) Pub. No.: US 2006/0168077 A1
(43) Pub. Date: Jul. 27, 2006

(54) Method and device for controlling a printer or a copier by accessing dtat objects by means of the network addresses associated with said data objects

(76) Inventors: Christoph Nemmaier, Munchen (DE); Helmut Sippel, Munchen (DE); Hubert Drexler, Taufkirchen (DE); Bernhard Holzner, St. Wolfgang (DE)

Correspondence Address: SCHIFF HARDIN, LLP;PATENT DEPARTMENT, 6600 SEARS TOWER, CHICAGO, IL, 60606-6473, US

(21) Appl. No.: 10/527,507

(22) PCT Filed: Sep. 25, 2003
(86) PCT No.: PCT/EP03/10689

§ 371 Date: Jan. 9, 2006

(30) Foreign Application Priority Data
Sep. 30, 2002 (DE) 102 45 528.7

(51) Int. Cl. G06F 15/16

(52) U.S. Cl. 709/207

(57) ABSTRACT

In a method and device for control of a printer or copier, data are transferred over at least one data line between at least a first control unit and a second control unit. Respectively one identifier is associated with the first and second control unit. At least one value of a data object is stored in a storage region of the second control unit. A third identifier is associated with the data object, whereby the first, second and third identifiers are network addresses.

### BACKGROUND

The preferred embodiment concerns a method and a device for control of a printer or copier. The printer or copier comprises at least two control units between which data are transferred via at least one data line. A first data object is stored in a storage region of the second control unit.

The administration of known printer or copier systems occurs via an operating unit of the printer or copier. A program element converts the operator inputs into accesses to data objects that in particular comprise control variables and constants. In modular-design control systems in known printers or copiers, these data objects are stored in all the control units in which they are necessary for control. Depending on the data connection between the control units, data objects stored in the control units cannot be directly accessed by the program for evaluation of the control panel inputs, whereby the modification of a data object and/or the display of a data object required elaborate processing steps.

In known printers or copiers, the data objects accessible via the control panel are additionally stored in a storage region of a central control unit. Given a printer downtime, these central control units would determine these data objects from the individual control units and would modify the data objects, given corresponding inputs via the control panel. Alternatively, the communication protocols with which the data transfer occurs between individual control units of the printer or copier are expanded by what are known as transparent communication, in that they are transported from a first control unit to a further second unit on preset paths without the first control unit itself analyzing the data.

However, in particular for maintenance purposes it is in particular desirable to obtain a direct access to data objects of the printer or copier by an external data processing unit via an interface of the printer or copier.

A network administration system for a digital printer that is based on a Simple Network Management Protocol (SNMP) is known from the document U.S. Pat. No. 6,119,156. A plurality of management or administrator systems can access two agents over a network with the aid of the SNMP.

From the document U.S. Pat. No. 6,314,089 B1, a data object is known that is dynamically generated and contains all information about connections that occur during a transaction. The object also contains information for specifications that have been used in a communication during a transaction. The communication at a transaction can thereby occur with the aid of a telephone, letters, faxes, e-mail and further transfer media.

A print system in which at least one parameter of one printer is monitored is known from the document DE 100 56 060 A1. With the aid of a sensor arrangement, a printing parameter is determined that, with the aid of a communication network, is transferred coded to a control arrangement that is connected with the printer via the communication network.

### SUMMARY

It is an object to specify a method and a device to control a printer or copier that enables or enable an access to data objects of the printer in a simple manner.

A method is provided for control of a printer or copier. Data are transferred between at least one first control unit and a second control unit via at least one data line. A first identifier is associated with the first control unit and a second identifier is associated with the second control unit. At least one data object is stored in a storage region of the second control unit. A third identifier is associated with the data object, the first, second, and third identifiers comprising network addresses.

### BRIEF DESCRIPTION OF THE DRAWINGS

FIG. 1 is a block diagram of a plurality of control units to control an electrophotographic printer; and

FIG. 2 is a block diagram in which is shown the hierarchical structure of the control units of the printer according to FIG. 1.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

In the method, both the control units and the data object stored in the second control unit receive a network address. The position of the data object is thereby unambiguously determinable, whereby the data object and thus the data of the data object can be directly accessed by each of the control units. The administration of the data object is thereby significantly simplified in a printer or copier (preferably in an electrophotographic printer or copier) with at least two control units. If, for example, a new data object is inserted or an existing data object is removed, the control procedures of all control units that only transfer data necessary for the access to the data object between the control units no longer have to adapted. With the aid of the network address of the data object, these data are simply forwarded to the control unit in which the data object is stored that is accessed. Routing tables that, in the prior art, must be present in all network nodes for association of the data object are no longer necessary due to the method.

A second aspect concerns a device to control a printer or copier that comprises at least two control units. The control units are connected with one another via at least one data line for transfer of data. A first identifier is associated with the first control unit and a second identifier is associated with the second control unit. At least one data object can be stored in a storage region of the second control unit. A third identifier is associated with the data object. The first, second and third identifiers are network addresses.

It is thereby achieved that the data object can be simply, directly accessed by an arbitrary control unit in a first network or a second network connected with the first network, without transfer path information for the forwarding of the request for readout or a request for writing having to be known on the transfer path to the control unit in which the data object is stored. If additional data objects are implemented in a second control unit, a first control unit connected with this second control unit via a data line can very simply access this data object as well as the data of the data object, in particular when the second control unit is hierarchically arranged multiple levels below the first control unit. Changes to control units that are hierarchically arranged between the first control unit and the second control unit are not necessary for access to the data object. The design of control systems can be significantly reduced via this very simple type of administration of data objects and the access to data objects, in particular of the variable administration and the variable access. Both the computation effort and the storage requirement of the individual control units can be significantly reduced by this device.

Such a device can advantageously be used to control an electrophotographic printer or copier.

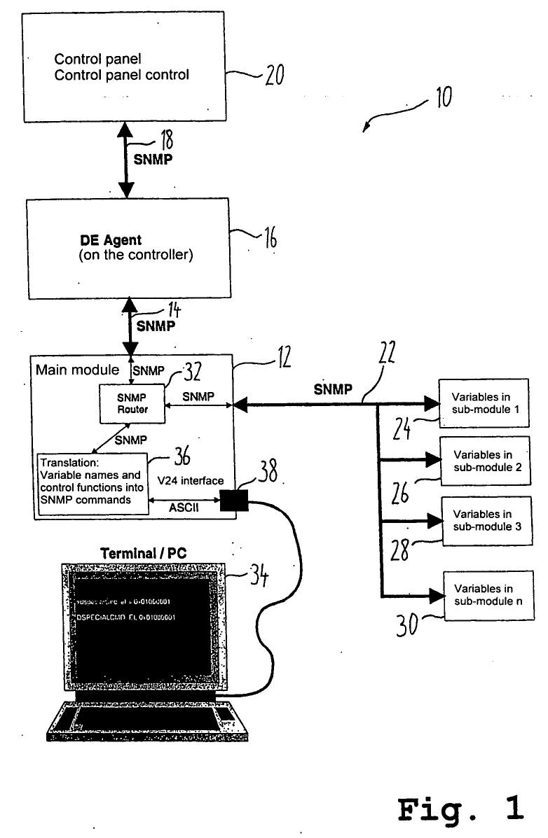

A control and maintenance system 10 of a printer (for example an electrophotographic printer) is shown in FIG. 1. A main control unit 12 is connected via a data line 14 with a control unit 16 that contains what is known as a print control agent. The print control agent is a software that is executed by the control unit 16 and, upon request, returns specific information that it has independently collected previously. The agent independently implements this collection and provision of information.

The control unit 16 is connected with the control panel unit 20 via a data line 18. The control panel control unit 20 controls outputs via a display unit of the printer and evaluates inputs that occur, for example, via a touch-sensitive screen. Given the printer control agent of the control unit 16, the control panel control unit 20 retrieves values of control variables collected and provided by the printer control agent as well as further data and data objects of the printer and outputs them on the display unit in suitable representation formats. The main control unit 12 is connected with further control units 24 through 30 via a network 22. Data objects, for example values of variables or values of constants that are necessary for control of the printer are stored in the control units 24 through 30. At least some of these data objects can be displayed on the control panel of the printer and can be modified by an operating personnel via the control panel. The values of other variables and/or constants are automatically changed with the aid of measurement values acquired by sensors.

The main control unit 12 is connected via a V.24 interface 38 with a personal computer 34 that is temporarily connected with the main control unit 12 for maintenance purposes and for adjustments as well as for error analysis. The data transfer of control commands to the main control unit 12 as well as of values and data from the main control unit 12 to the personal computer 34 occurs with the aid of what are known as ASCII characters and commands.

A converter unit 36 converts the ASCII control commands into control commands according to the Simple Network Management Protocol (SNMP). The data transfer over the data lines 14, 18 as well as over the network 22 also occurs with the aid of the Simple Network Management Protocol. The main control unit 12 furthermore comprises a router 32 that forwards both the data from the converter unit 36 to the control units 16, 24 through 30 and data from these control units 16, 24 through 30 to the converter unit 36. The data transferred from the control units 16, 24 through 30 to the converter unit 36 are converted by the converter unit 36 into ASCII data and transferred to the personal computer 34 via the V.24 interface 38.

In a simple manner, the main control unit 12 can thus access data objects that are stored in arbitrary control units 16, 20, 24 through 30 of the printer via the V.24 interface 38, whereby the values (i.e. the data of the data objects) can be read out and/or newly written. Thus data objects that in particular concern parameters of the printer that cannot be displayed or adjusted on the control panel can thus also be shown and modified with the aid of the personal computer 34.

The value of each data object is preferably stored in only one of the control units 12, 16, 24 through 30 and is read and/or written as needed by other control units via the network 22 and/or the data lines 14, 18. In other exemplary embodiments, at least some data objects are simultaneously stored in a plurality of control units, whereby the data of the data objects are synchronized at preset points in time.

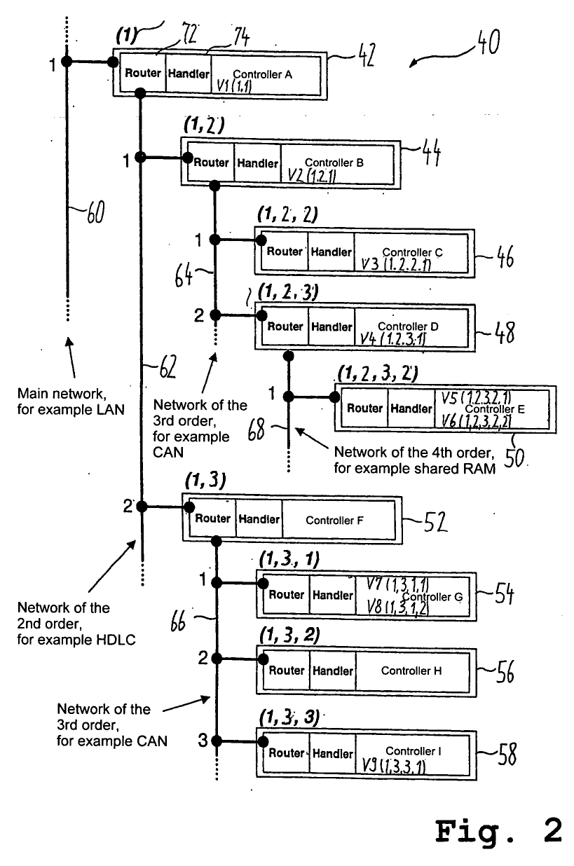

A control system 40 similar to the control system 10 according to FIG. 1 is shown in FIG. 2. The control system 40 has a tree-like structure and a hierarchical design. The individual hierarchy levels are also designated as layers. A main control unit 42 of the printer is connected with a superordinate network 60. The network 60 is, for example, a local area network (LAN). Subordinate control units 44, 52 are connected with the main control unit 42 via a network 62. The network 62 is operated with a synchronous control protocol, the High Level Data Link Control (HDLC). The control unit 44 is furthermore connected with a subordinate network 64 that is executed as a CAN bus. The control units 46, 48 are directly connected with the control unit 44 via this CAN bus.

The control unit 48 is furthermore connected with a subordinate network 68 that is, for example, executed as a shared RAM. The control unit 52 is connected with further control units 54, 56, 58 in a manner similar to that of the control unit 44. Each control unit 42 through 58 respectively comprises a router and what is known as a handler, whereby the router of the control unit 42 is designated with 72 and the handler of the control unit 42 is designated with 74. Handlers are generally program elements of a logical input-output system.

Respectively one address is associated with the control units 42 through 58, with which address they can be unambiguously identified in the hierarchical network structure of the control units 42 through 58. This address furthermore specifies a position in the network hierarchy, whereby the path from an arbitrary location of the network to this position can be determined with the aid of this address.

The address (1) is the main control unit 42, the address (1,2) is the control unit 44, the address (1,2,2) is the control unit 46, the address (1,2,3) is the control unit 48, the address (1,2,3,2) is the control unit 50, the address (1,3) is the control unit 52, the address (1,3,1) is the control unit 54, the address (1,3,2) is the control unit 56 and the address (1,3,3) is the control unit 58. Except for the control units 52 and 56, the other control units 42 through 50, 54, 58 respectively contain at least one variable V1 through V9. The variables V1 through V9 are stored in a storage region of the respective control unit 42 through 50, 54, 58 or in a storage region that is administrated by the respective control unit 42 through 50, 54, 58. The value of the variable V1 is stored in a storage region of the main control unit 42.

An address is associated with the variable V1, similar to one of the control units 42 through 58, whereby the address (1,1) that is hierarchically subordinate to the network address of the main control unit 42 is associated with the variable V1. The variable V2 is stored in a storage region of the control unit 44, whereby the network address (1,2,1) is associated with the variable V2. The network address (1,2,2,1) is associated with the variable V3 of the control unit 46 and the network address (1,2,3,1) is associated with the variable V4 of the control unit 48. The variables V5 and V6 are stored in a storage region of the control unit 50, whereby the network address (1,2,3,2,1) is associated with the variable V5 and the network address (1,2,3,2,2) is associated with the variable V6. The control unit 54 contains the variables V7 and V8. The variable V7 has the network address (1,3,1,1) and the variable V8 has the network address (1,3,1,2). The network address (1,3,3,1) is associated with the variable V9. The control units 52 and 56 contain no variables.

If, for example, the control unit 58 determines a new value for the variable V1 with the aid of a measurement value of a sensor, the control unit 58 transfers a corresponding item of information and the network address (1,1) to the network 66. This information, together with the network address (1,1) is transferred over the network 66 to the router of the control unit 52, which forwards the information (together with the network address (1,1)) to the superordinate network 62. The router of the control unit 52 checks beforehand whether the network address (1,1) of the control unit 52 is subordinate, i.e. whether the network address is an address in the network 66. However, the network address (1,1) of the variable V1 is not a network address hierarchically subordinate to the control unit 42. Thus the router transfers the network address (1,1) and the information to change the value of the variable V1 to the network 62, as already described. The network address (1,1) is transferred together with the information over the network 62 to the router of the control unit 44 and to the router 72 of the control unit 42. The router of the control unit 44 determines that the network address (1,1) does not concern the control unit 44 and none of the control units 46, 48, 50 hierarchically subordinate to this control unit 44.

The router 72 of the control unit 42 determines that the network address (1,1) is a network address that is hierarchically subordinate to the control unit 42. The router 72 transfers the network address (1,1) and the information to change the variable value of the variable V1 to the handler 74. The handler 74 determines that the network address (1,1) is associated with the variable V1. The handler 74 has direct access to the variable V1 or direct access to the storage region of the variable V1 and changes the value of the variable V1 in the storage corresponding to the transferred information. The handler 74 generates a confirmation message that is supplied to the control unit 56 over the networks 62 and 66. If the control unit 52 requires the value of the variable V6 for a control event, it sends a read request for the variable V6 to the network address (1,2,3,2,2). The control unit 52 transfers this request to the router of the control unit 52, which checks whether the network address (1,2,3,2,2) is a network address in the subordinate network 66. This is not the case, such that the router transfers this read request to the superordinate network 62.

The router of the control unit 44 checks whether the network address (1,2,3,2,2) is a network address subordinate to the control unit 44. This is the case, such that the router of the control unit 44 transfers the read request to the network 64. The router of the control unit 64 checks whether the network address (1,2,3,2,2) concerns a network address subordinate to the control unit 46. This is not the case. The router of the control unit 48 checks whether the network address (1,2,3,2,2) is a network address subordinate to the control unit 48. This is the case. The handler of the control unit 48 subsequently checks whether the network address concerns a variable stored in the control unit 48. This is not the case. The router of the control unit 48 thereupon transfers the read request to the network 68. The router of the control unit 50 checks whether the address (1,2,3,2,2) is a network address subordinate to the control unit 50. This is the case.

The router transfers the read request to the handler of the control unit 50. The handler of the control unit 50 determines that the network address (1,2,3,2,2) is associated with the variable V6. The value of the variable V6 is thereupon read out, and a response message is generated that contains the value of the variable V6. The message is sent back to the address of the control unit that has requested the value of the variable V6 on the transfer path in a direction essentially the reverse of how the read request was transferred to the control unit 50.

Via the association of a network address with the variables V1 through V9, each of these variables can be unambiguously addressed in the network. The access, i.e. the readout of the value of the variable or the writing of a new value of the values thereby simply occurs over the network from each point of the network. The accesses to variables can also occur across a plurality of networks given a coupling of a plurality of networks 60, 62, 64, 66, 68. Thus, for example, a variable can also be read out over the local area network 60 by a host computer connected to this network 60. For example it can thereby be implemented by this host computer in a very simple manner and without great effort from maintenance and setting jobs in which accesses to variables of control units 42 through 58 are necessary.

As specified in connection with FIG. 1, a maintenance computer 34 can also be directly connected with the control unit 42 in order to effect maintenance and setting jobs. The control unit 42 can thereby contain a converter unit 36, whereby the connection to the maintenance computer 34 is not directly suitable for transfer of maintenance messages according to SNMP. The converter unit 36 then translates the commands transferred by the maintenance computer 34 into SNMP commands that are then supplied to the corresponding control unit 42 through 58 and are executed by the respective control unit.

In addition or as an alternative to the SNM protocol, a CMI protocol (Common Management Information Protocol) can also be used in the arrangements according to FIG. 1 and FIG. 2. Individual processes of the processes to be processed by the data processing system can also serve as a control unit, in the sense of the preferred embodiment, which control unit is assigned a network address. The variable administered by these processes is then likewise assigned a network address, similar to the controllers 42 through 58. What are known as messages, pipes, named pipes and/or shared RAM are used as data transmission paths between the processes.

The control units 42 through 58 and 12, 16, 20, 24 through 30 can be executed both as separate components and as program elements that are executed in parallel in a control unit, for example as a task in a multitasking environment. A simpler exchange of values of variables is also possible via the association of network addresses with the variables, even given a plurality of tasks executed in parallel, i.e. given a plurality of processes executed in parallel. A central variable administration can thus be done away with. With the method or with the device, it is also no longer necessary that the same variable is present in parallel in multiple separate control units, whereby a synchronization of these variable values can also be omitted.

If the network addresses are hierarchically assigned as in the arrangement of the control units according to FIG. 2, the path to the control unit in which the respective variable V1 through V9 is stored can simply be determined using the network address. The transfer path to each network address, i.e. to each control unit and each variable for which a network address is associated, is unambiguously determined via such a hierarchical structure of the network addresses. An elaborate routing with the aid of routing tables or a searching of all network branches is dispensed with. The data traffic over the networks 60 through 68 can thereby be significantly reduced, whereby the capacity of the networks can be significantly increased. The routers of the control units 42, 44, 48, 52 act as a gateway between a plurality of networks. The control units 42, 44, 48, 52 furthermore serve as base nodes of the respective network or of the respective network branch. If applicable, these routers prepare the transferred data corresponding to the different network protocols. Thus at least the control units 42, 44, 48, 52 are designed as network nodes. The network addresses (1, 2, 2) of the controller 46 (in which the variable V3 is stored) can simply be derived from the network address (1, 2, 2, 1) of the variable V3, in that the last part (,1) of the network address (1, 2, 2, 1) is removed, which part serves as a course digit of the network addresses subordinate to the controller 46.

The method and the device for accesses to variables have been specified in detail in connection with FIG. 2. The method and the device can be used in the same manner for other data objects such as, for example, constants.

Although a preferred exemplary embodiment is displayed and specified in detail in the drawings and in the preceding specification, this should be viewed as purely exemplary and not as limiting the invention. It is noted that only the preferred exemplary embodiment is shown and specified, and all variations and modifications that presently and in the future lie within the protective scope of the invention should be protected.

In particular, the invention is not limited to electrophotographic printers or copiers, but rather can advantageously be used independent of the image generation methods used.

1-22. (canceled)

23. A method for control of a printer or copier, comprising the steps of:
transferring data between at least one first control unit and a second control unit via at least one data line;
associating a first identifier with the first control unit;
associating a second identifier with the second control unit;
storing at least one data object in a storage region of the second control unit; and
associating a third identifier with the data object, the first, second, and third identifiers comprising network addresses.

24. A method according to claim 23 wherein the network addresses are hierarchically organized and the third network address is hierarchically subordinate to the second network address.

25. A method according to claim 23 wherein the second network address is determined with aid of the third network address.

26. A method according to claim 24 wherein a transfer path for access to the data object is predetermined by a hierarchical position of the third network address.

27. A method according to claim 23 wherein data of the data object are read out from the storage region of the second control unit by the first control unit with aid of the third network address.

28. A method according to claim 23 wherein the first control unit and the second control unit respectively form a network node.

29. A method according to claim 25 wherein the third network address comprises a sub-address of the second network address.

30. A method according to claim 23 wherein a value of the data object specifies a setting parameter.

31. A method according to claim 23 wherein the control units are hierarchically organized, the second control unit being hierarchically subordinate to the first control unit, and the network address of the second control unit being hierarchically subordinate to the network address of the first control unit.

32. A method according to claim 23 wherein at least one third control unit is provided that is connected with the second control unit via a second data line and is hierarchically subordinate to the second control unit, the data object being read out by the third control unit via the second data line.

33. A method according to claim 23 wherein the first data line comprises one of the elements selected from the group consisting of a CAN bus connection, a LAN connection, a data line according to a V.24 standard, and a data line according to a SDLC standard.

34. A method according to claim 23 wherein the transfer over the first data line occurs with aid of the Simple Network Management Protol.

35. A method according to claim 23 wherein routers are provided in the control units, the routers forwarding a read request to at least one network address hierarchically superordinate to the data object.

36. A method according to claim 23 wherein a position of the data object in the network is determined with aid of the network address of the data object.

37. A method according to claim 32 wherein commands transferred by a fourth control unit according to a first data transmission standard are translated by the first control unit into commands of a second data transmission standard, and the data transferred to the first control unit by the second control unit according to the second data transmission standard are translated by the first control unit into data according to the first data transmission standard.

38. A method according to claim 23 wherein the first control unit is connected with the fourth control unit via a third data line, the fourth control unit being superordinate to the first control unit and has access to the data object with the aid of the first control unit.

39. A method according to claim 37 wherein the first, second and third control units are arranged in the printer or copier, and the fourth control unit is arranged outside of the printer or copier and is connected with the printer or copier over a third data line.

40. A method according to claim 37 wherein the third data line is designed according to a V.24 standard, and the printer or copier is connected with the fourth control unit for maintenance and setting jobs, the data of the data object being read out via the fourth control unit.

41. A method according to claim 37 wherein the fourth control unit comprises a personal computer with suitable software.

42. A method according to claim 23 wherein the first control unit comprises a base node of the network.

43. A method according to claim 23 wherein the data object contains an element selected from the group consisting of a variable and a constant.

44. A device to control a printer or copier, comprising:
at least one first control unit with which is associated a first identifier;
at least one second control unit with which is associated a second identifier;
at least one data line via which data is transferred between the first control unit and the second control unit;
the second control unit has a storage region in which at least one data object is storable; and
a third identifier is associated with the data object, the first, second and third identifiers comprising respectively a network address.

45. A method for control of a device which places indicia on a medium, comprising the steps of:
transferring data between a first control unit and a second control unit via a data line;
associating a first identifier with the first control unit;
associating a second identifier with the second control unit;
storing at least one data object in the second control unit; and
associating a third identifier with the data object, the first, second, and third identifiers comprising network addresses.
